(19) United States
(12) Patent Application Publication
(10) Pub. No.: US 2009/0272905 A1
(43) Pub. Date: Nov. 5, 2009

(54) WIRELESS X-RAY DETECTOR PLATE

(76) Inventors: Roderick Bernhard Richards, Frauenfeld (CH); Benjamin E. Schestopol, Portland, ME (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/115,253

(22) Filed: May 5, 2008

(51) Int. Cl. G01T 1/24; G01J 1/00; G01J 1/42

(52) U.S. Cl. 250/370.01; 250/336.1; 250/395

(57) ABSTRACT

The present disclosure provides for a wireless radiographic detector assembly. The assembly includes a detector plate having a first housing enclosing a radiation detector and a controller coupled to the radiation detector and a peripheral pack connected to the detector plate by a cable. The peripheral pack includes a second housing enclosing a wireless transmitter coupled to the controller and a power source for providing operating energy to the wireless transmitter and the detector plate.

### BACKGROUND

1. Technical Field

The present disclosure relates generally to wireless transmission of radiographic images, and in particular to wireless x-ray detector plates.

2. Background of Related Art

In x-ray imaging, x-rays are used to radiate objects to obtain images of internal structures and features of the object. X-ray imaging is widely used in the medical and dental fields for diagnosing various conditions and is especially useful for imaging bone tissue. Conventional x-ray imaging utilizes specialized x-ray film, which is exposed by the radiated x-rays. Presently, various x-ray detectors and converters are used to measure x-radiation exposure. The use of X-radiation detectors and converters provides great flexibility in designing x-ray imaging systems, such as wireless x-ray detector plates.

Wireless x-ray detectors are currently used in the dental field since the relatively small size of the detector plate for oral use only requires a compact power source. For general medical and veterinary imaging of larger objects, such as limbs, wireless x-ray plates can be particularly bulky since they require a multitude of components and more powerful and, hence, heavy power sources. Accordingly, there is a continuing need for improved wireless x-ray detectors, which overcome these drawbacks of the existing devices.

### SUMMARY

According to one embodiment of the present disclosure, a wireless radiographic detector assembly is disclosed. The assembly includes a detector plate having a first housing enclosing a radiation detector and a controller coupled to the radiation detector and a peripheral pack connected to the detector plate by a cable. The peripheral pack includes a second housing enclosing a wireless transmitter coupled to the controller and a power source for providing operating energy to the wireless transmitter and the detector plate.

According to another embodiment of the present disclosure, a wireless radiographic detector assembly is disclosed. The assembly includes a detector plate having a first housing enclosing a radiation detector and a controller coupled to the radiation detector, wherein the radiation detector is configured to convert radiation energy into electrical signals corresponding to radiation measurement values and the controller digitizes radiation measurement values to obtain radiographic data. The assembly also includes a peripheral pack connected to the detector plate by a cable. The peripheral pack including a second housing enclosing a wireless transmitter coupled to the controller and a power source for providing operating energy to the wireless transmitter and the detector plate, wherein the wireless transmitter processes the radiographic data from the controller for wireless transmission.

According to a further embodiment of the present disclosure, a wireless radiographic transmission system is disclosed. The system includes a wireless radiographic detector assembly having a detector plate. The detector plate includes a first housing enclosing a radiation detector and a controller coupled to the radiation detector, wherein the radiation detector is configured to convert radiation energy into electrical signals corresponding to radiation measurement values and the controller digitizes radiation measurement values to obtain radiographic data. The assembly also includes a peripheral pack connected to the detector plate by a cable. The peripheral pack including a second housing enclosing a wireless transmitter coupled to the controller and a power source for providing operating energy to the wireless transmitter and the detector plate, wherein the wireless transmitter processes the radiographic data from the controller for wireless transmission. The system also includes a radiographic image processing and display unit configured to receive the wireless transmission from the detector assembly and output the radiographic data as image data.

A method of taking a radiographic image is also contemplated by the present disclosure. The method includes the step of providing the wireless radiographic transmission system as discussed above. The method also includes the steps of identifying a target for imaging, positioning of the detector plate for imaging the target independent of positioning the peripheral pack and taking a radiographic image. The method further includes the steps of receiving the radiographic image on a display unit, viewing the radiographic image on the remote display unit and determining the quality of the radiographic image and rapidly retaking the radiographic image of the target if the quality of the radiographic image is determined to be insufficient to make a diagnosis.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of am illustrative embodiment of a system for wireless transmission of radiographic images according to the present disclosure; and

FIG. 2 is a schematic perspective cross-sectional view of a wireless radiographic detector plate according to the present disclosure.

### DETAILED DESCRIPTION

Particular embodiments of the present disclosure will be described herein below with reference to the accompanying drawings. In the following description, well-known functions or constructions are not described in detail to avoid obscuring the present disclosure in unnecessary detail.

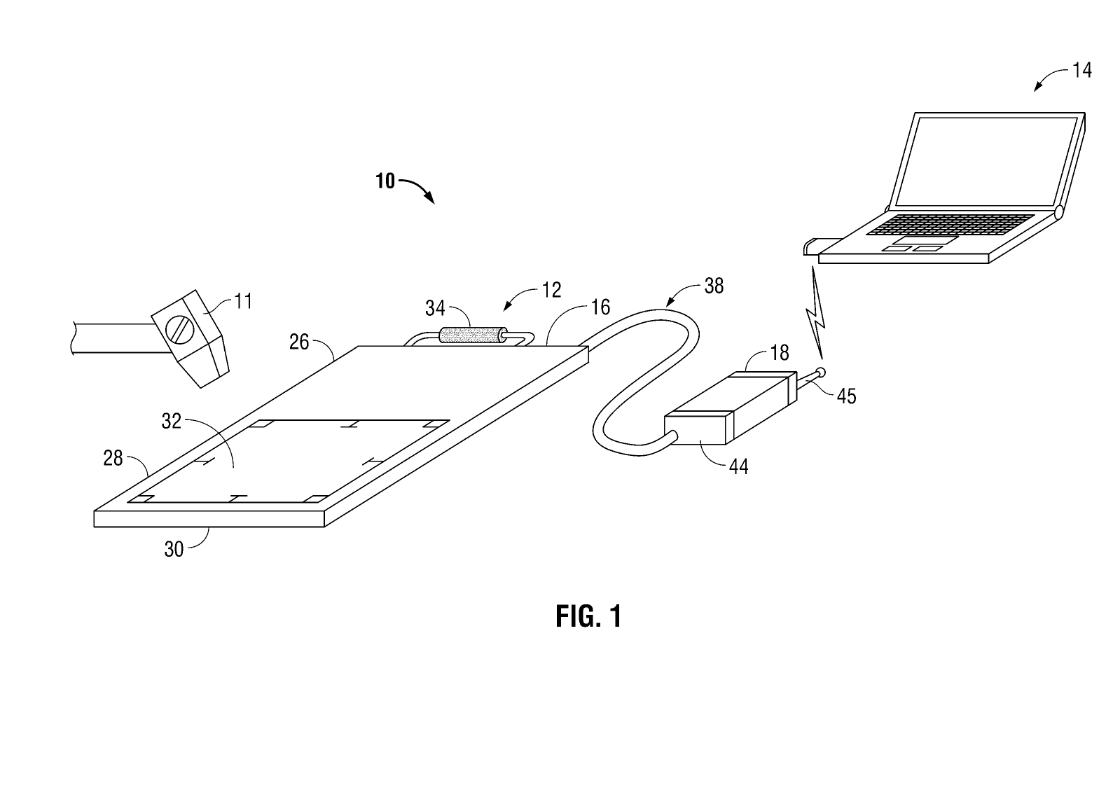

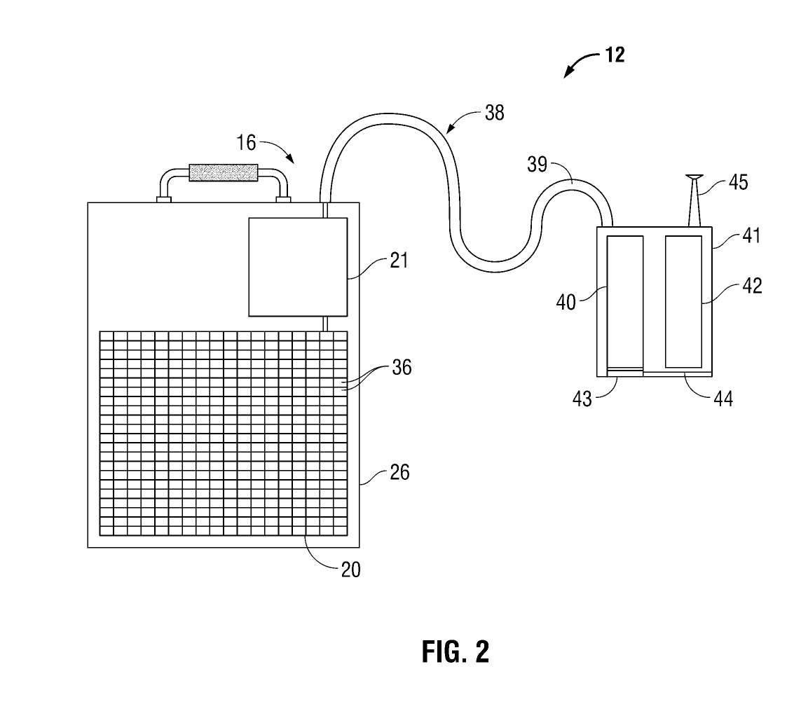

FIG. 1 shows a wireless radiographic transmission system 10 including a wireless radiographic detector assembly 12 and a radiographic image processing and display unit 14. The detector assembly 12 includes a detector plate 16, which houses a radiation detector 20 and a peripheral pack 18, which houses a power supply 22 and a wireless transmitter 24 as shown in more detail in FIG. 2. The detector assembly 12 is lightweight and portable allowing for the detector plate 16 to be positioned nearby an object (e.g., limb, torso, etc. of a patient or animal) to be radiographed without moving the object itself. A portable x-ray generator 11 may then be also moved into position to provide a source of x-rays for radiography.

The detector plate 16 has a substantially rectangular housing 26 enclosing the radiation detector 20 and a controller 21. The housing 26 includes a top side 28 and a bottom side 30. The top side 28 may have a reference target frame 32 which outlines the borders of the detector 20 to aid in the positioning of the detector plate 16 under or behind the object. The housing 26 may also include a handle 34 for carrying and positioning of the detector plate 16.

With reference to FIG. 2, the radiation detector 20 may include a plurality of detector elements 36 that convert radiation (e.g., x-rays) into electrical signals. The detector elements 36 may be photodiodes produced from amorphous silicone or selenium, CMOS chips, charge coupled devices or active pixel sensors, and the like, disposed in a two-dimensional matrix. The detector 20 may also include a converter layer such as a phosphor layer produced from a luminophore, disposed on the detector elements 36. The detector 20 is oriented with the converter layer toward the top side 28.

The controller 21 is coupled to the detector 20 and is configured to process the electrical signal corresponding to the detected radiation. The controller 21 may be any type of control logic circuitry such as a microprocessor, a microcomputer or any type of embedded device. The controller 21 may include a memory for storing operational instructions, firmware and/or programs for operating the detector 20. In particular, the controller 21 sequentially reads out the detector elements 36 and digitizes radiation measurement values. The measurement values are then processed and/or corrected according to radiographical processing algorithms stored in the controller 21 to obtain radiographic data.

As shown in FIGS. 1 and 2, the detector plate 16 is coupled to the peripheral pack 18 via a flexible cable 38. The peripheral pack 18 includes a substantially rectangular housing 41 enclosing a power source 40 and a wireless transmitter 42 as well as any other non-imaging components. The rectangular housing 41 may have an access panel 44 to provide for replacement of the power source 40. The cable 38 includes a flexible sheath 39, which houses various wires and/or cables interconnecting the power source 40 and the wireless transmitter 42 with the controller 21. The cable 38 may be about 7 meters or less to avoid signal loss. In addition, the sheath 39 may include shielding to prevent radio frequency interference.

The power source 40 provides power to all of the components of the detector assembly 12. The power source 40 may be a rechargeable battery (e.g., lead-based, nickel-based, lithium-ion based, etc.). The power source 40 may include one or more battery cells depending on the current load needs of the instrument 10. It is also envisioned that the power source 40 may be one or more disposable batteries. The power source 40 may be exchanged and recharged outside the peripheral pack 18. Further, the power source 40 may provide from about 9 volts to about 12 volts and have a capacity of about 2000 mAh or higher to provide for about 60 minutes of continuous operation of the detector assembly 12.

The power source 40 may be coupled to a power adapter 42, which is configured to connect to an external power source (e.g., DC transformer). The external power source may be used to recharge the power source 40 or provide for additional power requirements.

In another embodiment the power source 40 may be recharged using an inductive charging interface. For example, it may be coupled to an inductive coil (not shown) disposed within the housing 41. Upon being placed within an electromagnetic field, the inductive coil converts the energy into electrical current that is then used to charge the power source 40. The electromagnetic field may be produced by a base station (not explicitly shown) which is configured to interface with the housing 41, such that the inductive coil is enveloped by the electromagnetic field.

The wireless transmitter 42 is coupled to the controller 21 and is configured to process the digital radiographic data from the controller 21 for wireless transmission. The wireless transmitter 42 may be any type of electronic circuit configured to communicate over various types of wireless communication networks and protocols, such as infrared, WiFi, wireless broadband, Bluetooth, and the like. The wireless transmitter 42 may include an antenna 45, which may be disposed within the housing 18 or extend therethrough as shown in FIGS. 1 and 2.

The wireless transmitter 42 communicates with the display unit 14, which processes the wireless radiographic data from the detector assembly 12 and outputs the radiographic data as image data for analysis by the user (e.g., medical professional). The display unit 14 may be any computing device (e.g., personal computer, laptop, personal digital assistant, etc.) having hardware such as one or more central processing units (CPU) (e.g., processor), a random access memory (RAM), a read only memory (ROM) and input/output (I/O) interface(s) such as a keyboard, cursor control device (e.g., a mouse, touchpad, etc.) and display device.

The display unit 14 may also include an operating system or other operating instructions code (e.g., firmware), which may be stored in a data storage device. The various processes and functions described herein may either be part of the operating code or part of the application program (or a combination thereof) which is executed via the operating system. In addition, various other peripheral devices such as, for example, additional storage devices or a printer may be connected to the computer platform by various interfaces and bus structures, such as a parallel port, serial port or universal serial bus (USB). The display unit 14 may also be connected via a network to remote storage and display terminals, such as a hospital picture archiving communication system, for later analysis by remotely located users.

During operation, the detection plate 16 is positioned behind the object which is to be imaged. The x-ray generator 11 is then oriented toward the object and the detection plate 16 and x-ray radiation is emitted, which penetrates the object. The absorption pattern of the x-ray radiation passing through the object is detected by the detector 20 and processed by the controller 21. The controller 21 reads and if required, digitizes, intensifies and transduces the radiation measurements into radiographic data from each of the detector elements 36. The digital radiographic data from the controller 21 is then transmitted by the wireless transmitter 42 to the display unit 14. The display unit 14 processes the radiographic data to obtain image data and displays the image data for analysis by the user.

The hybrid configuration according to the present disclosure, in which the detector plate 16 includes the detector 20 and associated controller 21 in the housing 26 and the peripheral pack 18 includes the power source 40 and the wireless transmitter 42 in the housing 41, provides for a slim and portable detector plate 16 that is not overburdened with additional components, which are enclosed within the peripheral pack 18. The peripheral pack 18 may be worn on a belt and/or harness by the user allowing for easy maneuverability of the detector plate 16 behind the object of interest.

The detector plate 16 according to the present disclosure is particularly useful for rapid in-field radiographic imaging where access to conventional radiographic equipment is limited. A method of taking a radiographic image using the detector plate 16 is also contemplates by the present disclosure. The method includes the step of initially identifying a target for imaging (e.g., limb, torso, etc. of a patient or pet) and positioning the detector plate 16 behind the target for imaging. Since the detector plate 16 is connected to the peripheral pack 18 via the flexible cable 18, the detector pack 18 may be moved independent of the peripheral pack 18, while the peripheral pack 18 may be held stationary (e.g., worn by the user). Once the detector plate 16 is disposed behind the target, the radiographic image is taken and is transmitted to the display unit 14 as described above. The radiographic image is received by the display unit 14 and the user views the radiographic image on the remote display unit 14 to determine the quality of the radiographic image. If the quality of the radiographic image is determined to be insufficient to make a diagnosis, the user may rapidly retake the radiographic image of the target. The rapid retaking of an image may be within a relatively short period of time that elapses from the time the user views an image and is able to retake and view the image, such as from about 20 seconds about one minute. Due to the detector plate 16 being mobile relative to the peripheral pack 18, the detector plate 16 may be maneuvered behind the target (e.g., recenter the target) and retake the radiographic image.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1-14. (canceled)

15. A method of taking a radiographic image comprising:
providing a wireless radiographic transmission system, including:
a wireless radiographic detector assembly including:
a detector plate including a first housing enclosing a radiation detector configured to obtain radiographic data and a controller coupled to the radiation detector; and
a peripheral pack connected to the detector plate by a cable the perpheral pack including a second housing enclosing a wireless transmitter coupled to the controller and a power source for providing operating energy to the wireless transmitter and the detector plate, wherein the wireless transmitter processes the radiographic data from the radiation detector for wireless transmission; and a radiographic image processing and display unit configured to receive the wireless transmission from the detector assembly and output the radiographic data as image data;
identifying a target for imaging;
positioning of the detector plate for imaging the target independent of positioning the peripheral pack;
taking a radiographic image;
receiving the radiographic image on a display unit;
viewing the radiographic image on the remote display unit and determining the quality of the radiographic image; and
repositioning the detector plate and rapidly retaking the radiographic image of the target if the quality of the radiographic image is determined to be insufficient to make a diagnosis.

16. A method according to claim 15, wherein the radiation detector includes a plurality of detector elements configured to convert radiation energy into electrical signals corresponding to radiation measurement values.

17. A method according to claim 16, wherein the plurality of detector elements are selected from the group consisting of amorphous silicone photodiodes, amorphous selenium photodiodes, CMOS chips, charge coupled devices and active pixel sensors.

18. A method according to claim 16, further comprising the steps of:
reading from each of the plurality of the detector elements radiation measurement values; and
digitizing radiation measurement values to obtain radiographic data.

19. A method according to claim 15, wherein the detector plate includes a top side and a bottom side, the top side including a reference target frame which outlines the borders of the radiation detector.

20. A method of taking a radiographic image comprising:
providing a wireless radiographic transmission system including:
a wireless radiographic detector assembly including:
a detector plate including a first housing enclosing a radiation detector configured to obtain radiographic data; and
a peripheral pack connected to the detector plate by a cable, the peripheral pack including a second housing enclosing a wireless transmitter coupled to the detector plate and a power source for providing operating energy to the wireless transmitter and the detector plate, wherein the wireless transmitter processes the radiographic data from the radiation detector for wireless transmission; and
a radiographic image processing and display unit configured to receive the wireless transmission from the detector assembly and output the radiographic data as image data;
identifying a target for imaging;
positioning of the detector plate for imaging the target independent of positioning the peripheral pack;
capturing a radiographic image;
receiving the radiographic image on a display unit;
viewing the radiographic image on the remote display unit and determining the quality of the radiographic image; and
repositioning the detector plate and retaking the radiographic image of the target within a predetermined time period if the quality of the radiographic image is determined to be insufficient to make a diagnosis.

21. A method according to claim 20, wherein the radiation detector includes a plurality of detector elements configured to convert radiation energy into electrical signals corresponding to radiation measurement values.

22. A method according to claim 21, wherein the plurality of detector elements are selected from the group consisting of amorphous silicone photodiodes, amorphous selenium photodiodes, CMOS chips, charge coupled devices and active pixel sensors.

23. A method according to claim 21, further comprising the steps of:
reading from each of the plurality of the detector elements radiation measurement values; and
digitizing radiation measurement values to obtain radiographic data.

24. A method according to claim 20, wherein the detector plate includes a top side and a bottom side, the top side including a reference target frame which outlines the borders of the radiation detector.

25. A method according to claim 20, wherein the predetermined time period is from about 20 seconds to about 1 minute.
